(19) United States
(12) Patent Application Publication
(10) Pub. No.: US 2009/0083172 A1
(43) Pub. Date: Mar. 26, 2009

(54) SYSTEM AND METHOD FOR CONDUCTING REPO AND REVERSE-REPO SECURITIES TRANSACTIONS AT MARKET AVERAGE RATE

(76) Inventor: Scott E.D. SKYRM, New Canaan, CT (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/237,089

(22) Filed: Sep. 24, 2008

Related U.S. Application Data
(60) Provisional application No. 60/974,902, filed on Sep. 25, 2007.

(51) Int. Cl. G06Q 40/00

(52) U.S. Cl. 705/35

(57) ABSTRACT

A system and method for conducting repo market transactions, wherein the repo market transactions are made at a broker average market (“BAM”) rate based on an average transaction rate. The BAM rate can be based on a broker, or multiple brokers' average rate, either overnight or averaged over a term, and can be flat or at a plus or minus spread to the broker average.

### CROSS-REFERENCE TO RELATED APPLICATION

This application claims the benefit of U.S. Provisional Patent Application Ser. No. 60/974,902, filed Sep. 25, 2007; which application is incorporated herein by reference in its entirety for all purposes.

### TECHNICAL FIELD

The present invention relates generally to financial securities or instruments, and to market systems and transaction methods for trading financial securities.

### BACKGROUND OF THE INVENTION

The Repo and Reverse Repo market (herein called “repo market”) is one of the largest traded fixed income markets in the world. The repo market refers to the market for repurchase agreement financial instruments. In a repurchase agreement, a security is sold and the seller agrees to buy back the security at a price and date set prior to the sale. In effect, a repurchase agreement is a collateralized loan, in that the security serves as collateral.

Banks, broker-dealers and investors use the repo market to invest cash, cover short positions, and finance the purchase of securities. Repo trades represent one of the cheapest ways of financing because each transaction is a collateralized loan. A “screen based” trading system has developed over the years. Brokers (IDB—Inter Dealer Brokers) act as the meeting place for dealers and banks. Brokers typically offer two kinds of repo transactions traded on their computer screens (via direct line or internet), either overnight or term.

Traditionally, broker-dealers offer two kinds of repo transactions: overnight and term. An overnight trade is for just one day, and a vast majority of transactions are overnight. A term trade can be anywhere from two days out to a couple years. Most term trades have maturities within six months. Currently, there are no other kinds of repo trades traded in the market.

Repo transactions are conducted at a stated rate of interest or “repo rate.” Brokers typically publish their “weighted average” or “broker average” repo rate each day for all the securities they trade. The averages are comprehensive of the morning's trading, generally from 7:00 am to 10:00 am.

### SUMMARY OF THE INVENTION

In example forms, the present invention provides a system and method for conducting repo transactions at rates based on a daily or term weighted average rate.

In one aspect, the present invention is a system for conducting repo market transactions, wherein the repo market transactions are made at a “Broker Average Market” or “BAM” rate based on an average transaction rate.

In example form, the system for conducting repo market transactions includes a computer network for identifying a plurality of repurchase agreement transactions between sellers and buyers, each of the plurality of repurchase agreement transactions defining a transaction repo rate. The system further includes a processor for determining an average market rate based on the transaction repo rates of the plurality of repurchase agreement transactions, and a market for conducting repo market transactions at the determined average market rate.

In another aspect, the invention is a method for conducting repo market transactions, wherein the repo market transactions are made at a BAM rate based on an average transaction rate.

In example form, the method of conducting repo market transactions includes establishing a repo market for conducting a plurality of repurchase agreement transactions between sellers and buyers of securities, each of the plurality of repurchase agreement transactions defining a transaction repo rate. The method preferably also includes determining an average market rate based on the transaction repo rates of the plurality of repurchase agreement transactions, and conducting a repo market transaction at the determined average market rate.

In still another aspect, the invention is a repurchase agreement or repo financial instrument wherein a seller sells a security to a buyer and the seller agrees to buy back the security at a price and a date established prior to the sale. The price preferably includes interest based on a broker average market rate, and the security serves as collateral for the repurchase agreement.

In another aspect, the invention is a computer network for conducting repo market transactions, wherein the repo market transactions are made at a BAM rate based on an average transaction rate.

In another aspect, the invention is a computer readable media or memory element comprising computer executable software for conducting repo market transactions, wherein the repo market transactions are made at a BAM rate based on an average transaction rate.

In yet another aspect, the invention is a market for conducting repurchase agreement transactions wherein a seller sells a security to a buyer and the seller agrees to buy back the security at a price and a date established prior to the sale. The price includes interest based on a determined average market rate, and the security serves as collateral for the repurchase agreement

These and other aspects, features and advantages of the invention will be understood with reference to the detailed description herein, and will be realized by means of the various elements and combinations particularly pointed out in the appended claims. It is to be understood that both the foregoing general description and the following detailed description of the invention are exemplary and explanatory of preferred embodiments of the invention, and are not restrictive of the invention, as claimed.

### DETAILED DESCRIPTION OF EXAMPLE EMBODIMENTS

The present invention may be understood more readily by reference to the following description of the invention. It is to be understood that this invention is not limited to the specific devices, methods, conditions or parameters described herein, and that the terminology used herein is for the purpose of describing particular embodiments by way of example only and is not intended to be limiting of the claimed invention.

The present invention provides a system and method for conducting repo transactions at rates based on a daily or term weighted average rate. For example, the system and method of the invention may provide for transactions at a published or determined “Broker Average Market” or “BAM” rate, whereby two counter parties transact a trade at the broker average. One is the buyer of the security and one is the seller. The repo rate is determined by the weighted average of the transaction rates where that security trades in one or more of the brokers' markets that day.

Clients can bid/offer at a flat spread (±0) or a spread to the broker average. A trade done at +1 means the rate will be the broker average plus one basis point. The broker average rate is determined after the 10:00 am averages are published by the Brokers.

A term BAM trade is at the average of the daily averages for more than one day. For example, for a two-day BAM term trade done “flat” (±zero basis points) to the average and the BAM overnight average is 4.75% the first day and 4.85% the second day, the repo rate on the two-day BAM trade would be 4.80%. (The sum of BAM overnight rates divided by number of days). If the trade was done at +1 then the BAM term rate would be 4.81%

In alternate forms of the invention, overnight or term trades can be conducted at rates based on published or calculated measures other than the broker average, and/or the system and method of the invention can be applied to financial markets other than the repo market. Also, the invention includes both the methods of conducting trades described herein, as well as systems and markets established for carrying out such methods. The system and method of the invention can be carried out in tandem with other transactions in existing financial markets, and/or in separately established markets. In example forms, the system and method of the present invention are implemented on a computer network such as the internet or a private intranet. The invention further includes software for carrying out the systems and methods herein described, as well as various forms of computer readable media comprising such software.

While the invention has been described with reference to preferred and example embodiments, it will be understood by those skilled in the art that a variety of modifications, additions and deletions are within the scope of the invention, as defined by the following claims.

What is claimed is:

1. A repurchase agreement wherein a seller sells a security to a buyer and the seller agrees to buy back the security at a price and a date established prior to the sale, and wherein the price includes interest based on a broker average market rate, and wherein the security serves as collateral for the repurchase agreement.

2. The repurchase agreement of claim 1, wherein the broker average market rate is determined based on a weighted average of transaction rates at which the security trades in at least one market on at least one day.

3. The repurchase agreement of claim 1, wherein the broker average market rate is determined based on an average transaction rate and a spread.

4. The repurchase agreement of claim 1, wherein the broker average market rate is determined based on a multi-day average of a plurality of daily average transaction rates.

5. The repurchase agreement of claim 1, wherein the broker average market rate is determined based on an average transaction rate for a single day.

6. A method of conducting repo market transactions, said method comprising:
establishing a repo market for conducting a plurality of repurchase agreement transactions between sellers and buyers of securities, each of said plurality of repurchase agreement transactions defining a transaction repo rate;
determining an average market rate based on the transaction repo rates of the plurality of repurchase agreement transactions; and
conducting a repo market transaction at the determined average market rate.

7. The method of claim 6, wherein the determined average market rate is a broker average rate.

8. The method of claim 7, wherein the plurality of repurchase agreement transactions comprise overnight transactions, and the broker average rate is a daily broker average rate.

9. The method of claim 7, wherein the plurality of repurchase agreement transactions comprise multi-day term transactions, and the broker average rate is based on an average of the daily broker averages for more than one day.

10. The method of claim 6, wherein the determined average market rate is an average of the transaction repo rates adjusted by a spread.

11. In a system for conducting repo market transactions, comprising a computer network for identifying a plurality of repurchase agreement transactions between sellers and buyers, each of said plurality of repurchase agreement transactions defining a transaction repo rate, the improvement comprising:
a processor for determining an average market rate based on the transaction repo rates of the plurality of repurchase agreement transactions; and
a market for conducting repo market transactions at the determined average market rate.

12. The system of claim 11, wherein the determined average market rate is a broker average rate.

13. The system of claim 12, wherein the repo market transactions comprise overnight transactions, and the broker average rate is a daily broker average rate.

14. The system of claim 12, wherein the repo market transactions comprise multi-day term transactions, and the broker average rate is an average of the daily broker averages for more than one day.

15. The system of claim 11, wherein the determined average market rate is an average of the transaction repo rates adjusted by a spread.

16. Computer readable media operable on the system of claim 11, and comprising software executable by the processor for determining the average market rate based on the transaction repo rates of the plurality of repurchase agreement transactions.

17. A market for conducting repurchase agreement transactions wherein a seller sells a security to a buyer and the seller agrees to buy back the security at a price and a date established prior to the sale, and wherein the price includes interest based on a determined average market rate, and wherein the security serves as collateral for the repurchase agreement.

18. The market of claim 17, comprising at least one broker, and wherein the determined average market rate comprises a broker average market rate for the security.

19. The market of claim 17, wherein the determined average market rate is a daily average rate.

20. The market of claim 17, wherein the determined average market rate is a term average rate for a plurality of days.
